(19) United States
(12) Patent Application Publication
(10) Pub. No.: US 2014/0181910 A1
(43) Pub. Date: Jun. 26, 2014

(54) SYSTEMS AND METHODS FOR ENABLING PARENTAL CONTROLS BASED ON USER ENGAGEMENT WITH A MEDIA DEVICE

(71) Applicants: Jim Fingal, Cambridge, MA (US); Brian C. Peterson, Barrington, IL (US); Francis Chan, San Diego, CA (US)

(72) Inventors: Jim Fingal, Cambridge, MA (US); Brian C. Peterson, Barrington, IL (US); Francis Chan, San Diego, CA (US)

(21) Appl. No.: 13/725,084

(22) Filed: Dec. 21, 2012

(51) Int. Cl. H04L 29/06

(52) U.S. Cl. CPC H04L 63/102
USPC 726/4

(57) ABSTRACT

Systems and methods are described for controlling playback of media assets. In some aspects, the systems and methods described detect a first user within proximity of a user equipment device. The systems and methods detect a second user, who is restricted from accessing a media asset on the user equipment device without a first user within proximity of the user equipment device who has a content authorization level higher than the second user. Processing circuitry measures the first user's engagement level with the user equipment device. The processing circuitry retrieves a threshold value from the user equipment's memory and determines whether the measured engagement level of the first user with the user equipment device is above the retrieved threshold. If the measured engagement level of the first user with the user equipment device is above the threshold, processing circuitry enables access to the media asset.

### BACKGROUND

Traditional parental control systems simply filter media content that a child is not allowed to view. In the case of television receivers, these systems typically comply with the mandate set forth by the Federal Communications Commission (FCC) requiring television receivers with screens 13 inches or greater to be equipped with technological features to allow parents to block the display of violent, sexual, or other programming they believe to be harmful to their children. However, a parent may find these parental control systems to be inflexible. For example, if the parent judges that certain media content is fit for their child's consumption in their presence, the parent must manually change the parental control settings for the media content to allow the content to be displayed. Therefore, there is a need for systems that provide a parent with a more flexible mechanism for filtering content that their children can access.

### SUMMARY

In view of the foregoing, the systems and methods described herein provide an efficient and seamless mechanism for a parent to allow a child access to certain media content in their presence. Parental control settings based on a strict set of rules to block certain media content to certain users are often too mechanical and may not be well suited for a family viewing the same media content. Instead, parental control settings for media content may be more effective when the user equipment device is implemented with a more context aware system. A system that allows a child to view a less restrictive set of content as long as the parent is present and engaged with the media content being viewed is referred to herein as a context aware parental control system or a context aware media control system.

For example, the systems and methods described provide for allowing a child access to media content under active parental supervision. In some embodiments, when a child enters a viewing region of a user equipment device where a parent may be accessing certain media content, processing circuitry may check parental control settings for the child to determine whether the child is allowed to access the media content being viewed by the parent. If the child is allowed to access the content with active parental supervision, the processing circuitry may measure the parent's level of engagement with the user equipment device to determine if the parent is paying sufficient attention to the media content. If the processing circuitry determines that the parent is paying attention to the media content above a certain threshold, the processing circuitry may allow the child access to the media content at the user equipment device. If the processing circuitry determines that the parent is not paying sufficient attention to the media content, the child may no longer access the media content at the user equipment device.

In some aspects, the systems and methods described control playback of media assets. The systems and methods described may detect a first user within proximity of a first user equipment device. The systems and methods may detect a second user within proximity of the first user equipment, who is restricted from accessing a media asset on the first user equipment device without a first user within proximity of the first user equipment device. The first user has a content authorization level higher than the second user. Processing circuitry may measure an engagement level of the first user with the first user equipment device. Processing circuitry may retrieve a threshold value stored in a memory of the first user equipment device. The processing circuitry may determine whether the measured engagement level of the first user with the first user equipment device is above the retrieved first threshold value. If the measured engagement level of the first user with the first user equipment device is above the first threshold, the processing circuitry may enable access to the media asset at the first user equipment device.

In some embodiments, the systems and methods described include determining whether the first user is allowed to access the media asset by accessing a first user profile. In some embodiments, the media asset is accessed upon determining that the first user is allowed to access the media asset.

In some embodiments, the systems and methods described include tracking the facial position of the first user with respect to the first user equipment device to measure the engagement level of the first user with the first user equipment device.

In some embodiments, the systems and methods described measure the level of engagement of the first user with the first user equipment device by tracking the gaze of the first user with respect to the first user equipment device. Processing circuitry may set a value for the level of engagement of the first user with the second user equipment device based on the gaze-tracking.

In some embodiments, the systems and methods described include accessing a second user profile for the second user upon detecting that the second user is within proximity of the first user equipment device. The processing circuitry may determine whether the second user profile prevents access to the media content and may prevent access to the media content upon determining that the measured level of engagement of the first user with the first user equipment device is below the threshold.

In some embodiments, the systems and methods described include determining whether the first user is engaged with a second user equipment device and measuring the level of engagement of the first user with the second user equipment device. Upon determining that the measured level of engagement of the first user with the second user equipment device is above a second threshold, access may be prevented to the media asset at the first user equipment device. Measuring the level of engagement of the first user with the second user equipment device may include monitoring which application the first user is using on the second user equipment device. A value may be assigned to the level of engagement of the first user with the second user equipment device based on the application that the first user is using on the second user equipment device.

In some embodiments, measuring the level of engagement of the second user equipment device may include tracking the gaze of the first user with respect to the second user equipment device and accordingly setting a value to the level of engagement of the first user with the second user equipment device based on the gaze-tracking.

In some embodiments, the systems and methods described include assigning a value to the level of engagement of the first user with the first user device and comparing the level of engagement value with the first threshold stored in a database.

It should be noted that the systems and/or methods described above may be applied to, or used in accordance with, other systems, methods and/or apparatuses.

### BRIEF DESCRIPTION OF THE DRAWINGS

The above and other objects and advantages of the systems and methods described herein will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information;

FIG. 2 shows another illustrative embodiment of a display screen that may be used to provide media guidance application listings;

FIG. 3 shows an illustrative embodiment of a user equipment device;

FIG. 4 shows a block diagram of an illustrative embodiment of a cross-platform interactive media system;

FIG. 5A is an illustrative embodiment of a block diagram of an eye tracker for identifying the gaze point of a user of user equipment;

FIG. 5B is another illustrative embodiment of a block diagram of a face tracker for identifying the gaze point of a user of user equipment in accordance with an embodiment;

FIG. 6 depicts an illustrative environment in which a parent and a child are viewing media content using context aware media control system in accordance with an embodiment;

FIG. 7 depicts another illustrative environment in which a parent is using a smartphone while a child is viewing a media content using a context aware media control system in accordance with an embodiment;

FIG. 8 shows an illustrative embodiment of a display screen of a user equipment device where a parent is not completely engaged with the user equipment device;

FIG. 9 shows an illustrative embodiment of a display screen of a user equipment device where the parent resumes to be engaged with the user equipment device;

FIG. 10 shows an illustrative embodiment of a flow diagram depicting a process in which access to a media asset is granted on a user equipment device when only one user is allowed to access the device by himself; and

FIG. 11 shows an illustrative embodiment of a flow diagram depicting a process in which a user engagement level is calculated for a user with respect to a user equipment device.

### DETAILED DESCRIPTION OF EMBODIMENTS

Parental control settings based on a strict set of rules to block certain types of programming to certain users are often too mechanical and may not be well suited for a family viewing content. Instead, parental control settings for media content may be more effective when the media device is implemented in a more context aware manner. A system that allows a child to view a less restrictive set of content as long as the parent is present and engaged with the media content being viewed is referred to herein as a context aware parental control system or a context aware media control system.

Without the presence of a parent in proximity of the context aware media control system, the child may only be allowed to access media content that conforms to a restrictive set of rules that the parent has enabled on the media device. For example, parental control settings may only permit a child to access media content associated with certain parental guidance ratings set by the FCC (e.g., TV-Y, TV-Y7, TV-G) or the Motion Pictures Association of America (MPAA) (e.g., G, PG, PG-13). Meanwhile a parent may have a higher content authorization level to access a less restrictive set of media content than the child. For example, parents may be able to access content rated TV-PG, TV-14, TV-MA, R, or NC-17.

However, parents may wish to have the freedom to view specific media content with their child that the child may not be allowed to view without any parental supervision. By monitoring the parent's level of attention to the media device, the context aware media control system allows access to certain content not otherwise accessible to the child without active parental supervision.

Once the context aware media control system detects that a parent is present in the proximity of the media device, the context aware media control system checks to see whether the parent is paying attention to the media device. If the parent is indeed engaged with the media device, then the child is allowed to view a less restrictive set of media content due to the parental supervision. For example, a child may be allowed to access only media content with ratings of TV-Y, TV-Y7, and TV-G without parental supervision. However, when a parent is present and determined to be adequately engaged with the media device, the child may be allowed to view media content with a TV-PG rating.

Since the parent is determined to be paying attention to the media content accessed on the media device, he is free to change the level of access to the content if he finds it objectionable at any time. Such a technique confers a greater degree of control over the parental control feature to an attentive parent. The parent is no longer limited to viewing a limited set of programs merely because a child is present in front of the television. Rather, the attentive parent is given control over the parental control feature.

Once the parent is determined to be inattentive or disengaged with the media device, the context aware media control system reverts to allowing the child to only access media assets that he is allowed to access without parental supervision. Such a reversion to allowing a restricted set of media assets to be accessed on the media device as the parent's level of engagement with the media device drops is another technique in which the context aware media control system confers the parental control decision to the parent. When the system determines that the parent is not paying attention to the media content, the context aware media control system realizes that the parent is unavailable to provide his parental control supervision. In this situation, the context aware media control system reverts to a simpler rule-based parental control feature in which the child is allowed to access a limited set of media assets that are appropriate for the child.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application. The context aware media control system may be implemented through such an interactive media guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

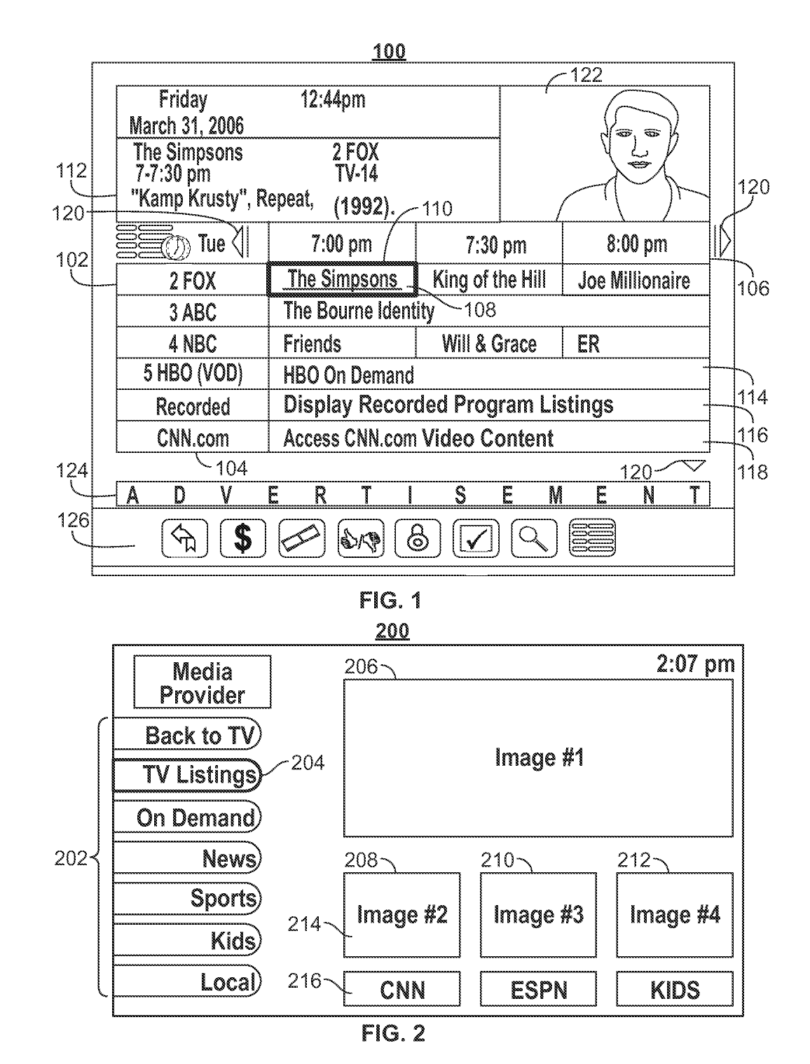

FIGS. 1-2 show illustrative display screens that may be used to provide media guidance data. The display screens shown in FIGS. 1-2 and 5-15 may be implemented on any suitable user equipment device or platform. While the displays of FIGS. 1-2 and 5-15 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

Each user profile may contain parental control restrictions. A user profile may be configured with access to specific types of content. Access to specific types of content may be configured by establishing access rules such as allowing a user with a specific user profile access to media content associated with certain parental control ratings. A user profile may also contain more specialized parental control settings such as blocking access to media content associated with certain genres, subjects, and actors. Parental control settings may also prevent the user of a specific user profile from accessing certain content sources or prevent the user from accessing specific content sources at certain times of the day.

Once a user profile is set up with these access rules, the media guidance application may check the access rules once a media asset is requested to determine whether the user associated with a specific user profile is allowed to access the requested media content. Alternatively, the media guidance application may search all media content listings available in a media guidance database to determine which media assets the user profile is allowed to access.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

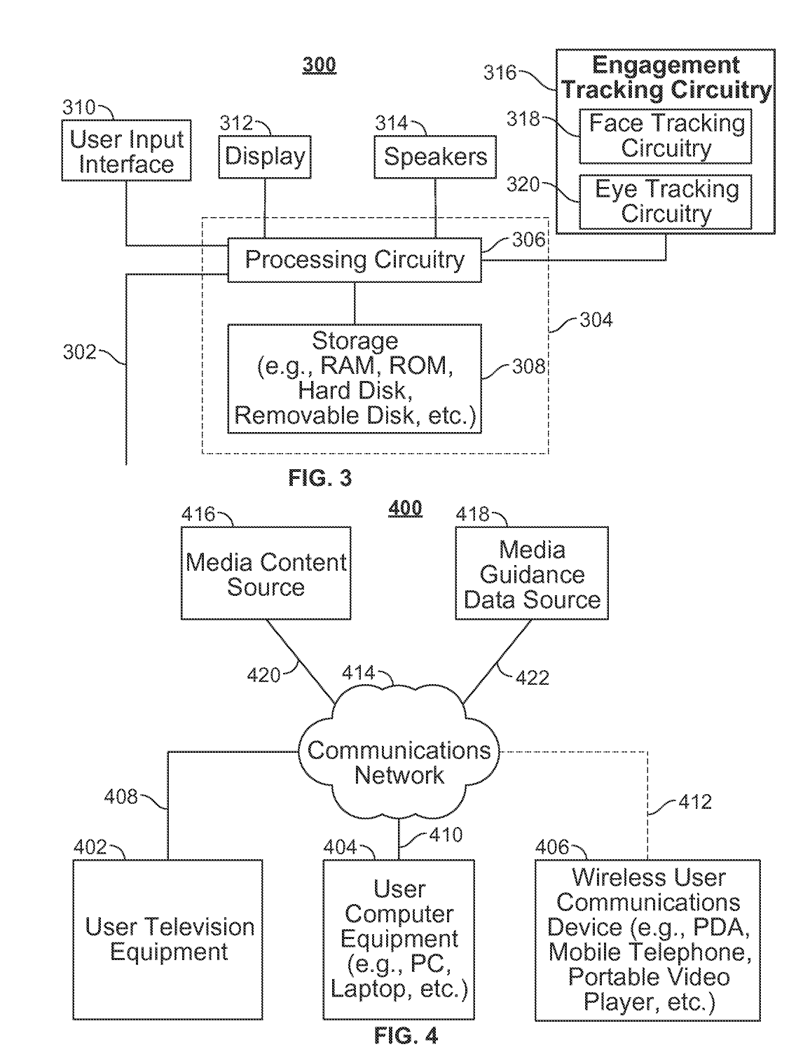

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

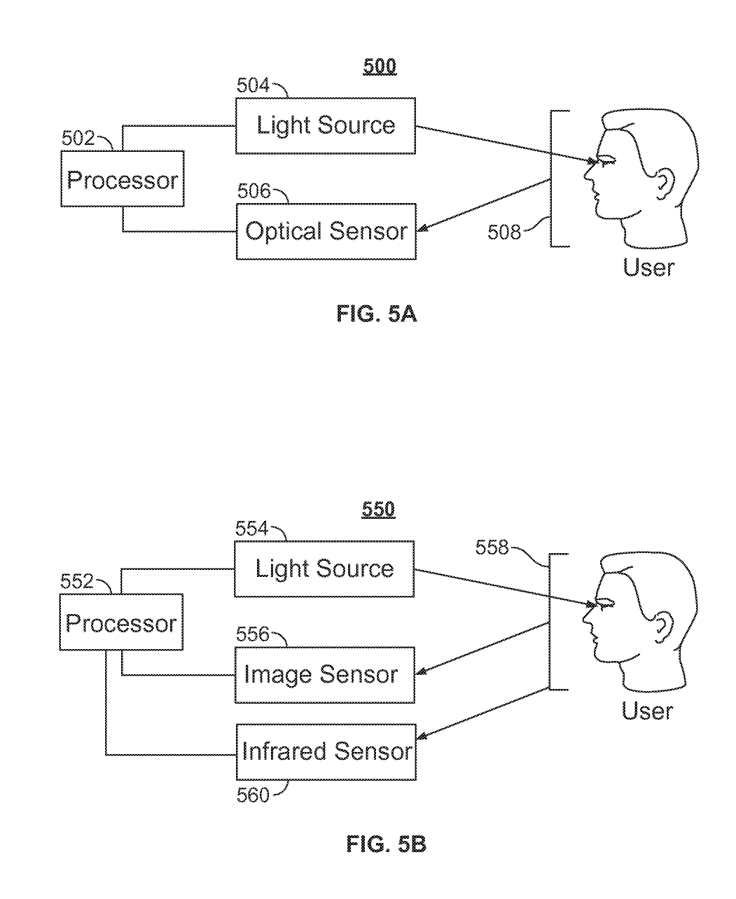

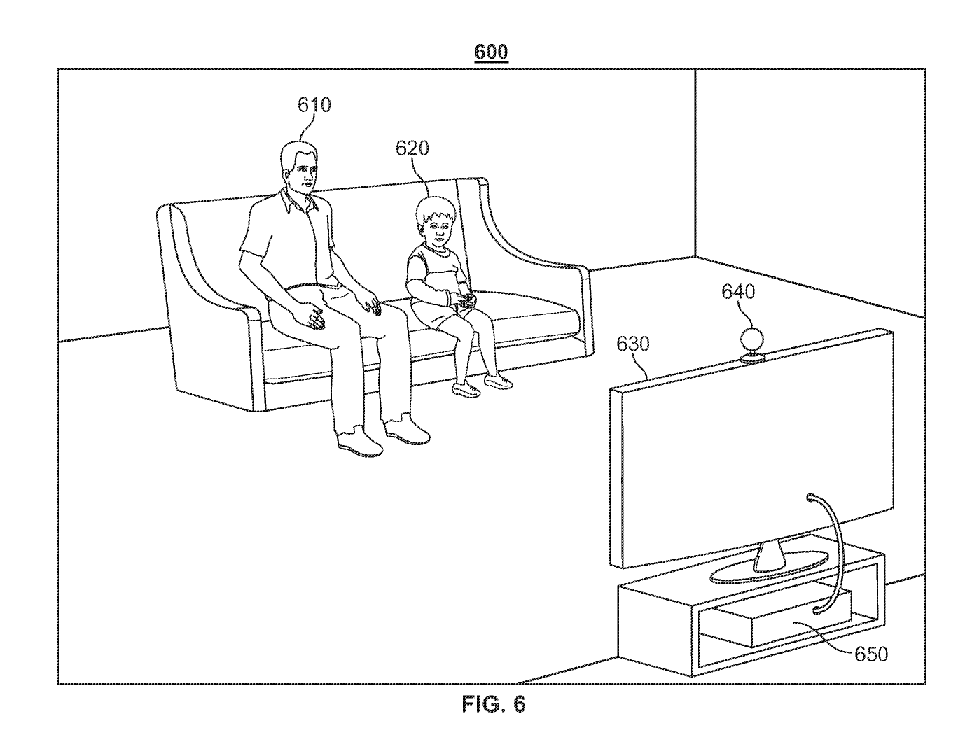

User equipment device 300 may determine a user's level of engagement with display 312 using engagement tracking circuitry 316. In several embodiments, engagement tracking circuitry 316 may contain an eye tracker 320. Eye tracker 320 may receive a location upon which one or both of a user's eyes are focused. The location upon which a user's eyes are focused is referred to herein as the user's “gaze point.” In some embodiments, eye tracker 320 may monitor one of both eyes of a user of user equipment 300 to identify a gaze point on display 312 for the user. Eye tracker 320 may additionally or alternatively determine whether one or both eyes of the user are focused on display 312 or focused on a location that is not on display 312. In some embodiments, eye tracker 320 includes one or more sensors that transmit data to processing circuitry 306, which determines a user's gaze point. Eye tracker 320 may be integrated with other elements of user equipment device 300, or eye tracker 320 may be a separate device or system in communication with user equipment device 300. Eye tracker 320 is described in further detail in relation to FIG. 5.

In some embodiments, control circuitry 304 may be configured to assign an engagement level value based on the monitored eye tracking data. For example, control circuitry 304 may receive the gaze tracking data collected by eye tracker 320 and store that data in a memory unit such as storage 308. Control circuitry 304 may analyze the location of the gaze point with respect to display 312 to determine the engagement level of the user with respect to display 312. Control circuitry 304 may calculate an eye tracking score on the location of the user's gaze point at a given time with respect to display 312. Control circuitry 304 may store the calculated eye tracking score in a database in storage 308. Control circuitry 304 may factor in the eye tracking score along with several other parameters used to measure a user's engagement level to calculate a user engagement level value with user equipment device 300.

In several other embodiments, engagement tracking circuitry 316 may include face tracker 318. Face tracker 318 may determine the position and orientation of the user's face with respect to display 312 in order to measure the level of user engagement with the displayed media asset. Face tracker 318 may use an optical device and facial recognition software in order to detect a user's face. Once a user's face has been detected, face tracker 318 may compare the detected face against a database of known user faces stored in a database in storage 308 using facial recognition software. For example, face tracker 318 may use an optical device to capture an image of a detected face within proximity of user equipment device 300. Face tracker 318 may then use facial recognition software to process the captured image and compare the processed image against a database of registered users' faces stored in a database on storage 308. Once a matching face in the database of users' faces is found, processing circuitry 306 may identify the user profile associated with the detected face.

Face tracker 318 may monitor the position and orientation of the detected user's face once a matching user profile has been identified with the detected user's face. In particular, face tracker 318 may monitor the tilt of the face with relation to display 312. For instance, face tracker 318 may monitor whether the user is facing display 312 or whether the user's face has turned sideways and is not looking directly at display 312. The degree of the tilt between the user's face and display 312 is used to measure the engagement level of the user. Face tracker 318 may also monitor the position of the user's face with relation to display 312 to determine the distance between the user's face and display 312 and to determine the angle of the user's face from the center of display 312. Such data collected by face tracker 318 determines how likely the user is to be engaged with the media asset displayed on display 312.

In some embodiments, control circuitry 304 may be configured to assign an engagement level value based on the monitored face tracking data. For example, control circuitry 304 may receive the face tracking data collected by face tracker 318 and store that data in a memory unit such as storage 308. Control circuitry 304 may analyze data describing the user's facial orientation with respect to display 312 to determine the level of engagement of the user with the user equipment device 300. For instance, control circuitry 304 may calculate a face tracking score based on the angle of the user's face with respect to display 312 measured by face tracker 318. Control circuitry 304 may additionally factor in the user's facial position with respect to display 312 to calculate the face tracking score. Once control circuitry 304 calculates such a face tracking score, control circuitry 304 may calculate an engagement level value using the face tracking score. For instance, control circuitry 304 may perform a weighted average of the face tracking score and the eye tracking score to calculate a total user engagement level value with user equipment 300.

Control circuitry 304 may store the calculated engagement level value in a database in storage 308. Control circuitry 304 may assign such an engagement level at periodic time intervals or continuously update a database of user engagement level with values of user engagement values based on the monitored eye tracking data received from eye tracker 320. In some embodiments, control circuitry 304 may also transmit the user's calculated engagement level value to other user equipment devices over a wireless network.

In some embodiments, face tracker 318 may capture a video of the user's face to measure the engagement level of the user. Alternatively, face tracker 318 may capture a set of image frames of a user's face. Control circuitry 304 may check for differences in facial features between different video frames or captured images. Control circuitry 304 may compare the differences in facial features, position, and orientation with respect to display 312 to update the user engagement level. For instance, control circuitry 304 may measure the change in facial features, position, and orientation with respect to display 312 for an image frame with respect to such data from an initial image frame. Control circuitry 304 may then accordingly adjust the face tracking score proportionately with respect to the offsets in these measured facial values for an image captured after an initially captured image of the user's face.

Face tracker 318 and eye tracker 320 may be used in combination to determine the engagement level of a user associated with a user profile with display 312. Processing circuitry 306 may use gaze tracking data and facial position and orientation data in combination to determine a composite score of the user's level of engagement with display 312. For example, processing circuitry 306 analyzes the face tracking and eye tracking data for each user and calculates a composite user engagement level score based on the analyzed data.

Engagement tracking circuitry 316 may also monitor whether a user is interacting with a secondary device in addition to user equipment device 300 to further refine the calculated value for a user's level of engagement with display 312. For instance, engagement tracking circuitry 316 may detect other electronic devices that the user is paying attention to.

In several embodiments, engagement tracking circuitry 316 detects whether a user is engaged with another user equipment device. Engagement tracking circuitry 316 may include a wireless transmitter and receiver for communicating with other user equipment devices over a wireless local area network connection. Engagement tracking circuitry 316 may transmit the user's level of engagement value with display 312 of that user equipment device to another user equipment device's engagement tracking circuitry. Once engagement tracking circuitry 316 receives the level of engagement value from another user equipment device, engagement tracking circuitry 316 adjusts the engagement level value of the user associated with a specific user profile with relation to its own display. Engagement tracking circuitry 316 may reduce the level of engagement of a user with a given device proportionately with respect to the user's level of engagement with another device. For instance, engagement tracking circuitry 316 may reduce the level of engagement value for a given device if it receives a high level of engagement value for the same user with another user equipment device. Engagement tracking circuitry 316 may decrease the engagement level value that may have been previously stored in storage 308 by an amount proportionate to the received user engagement level with another device. In another implementation engagement tracking circuitry 316 may reduce the engagement level value calculated by the face tracking and eye scores before storing the computed engagement level value into storage 308.

A local network of user equipment devices communicating user engagement level values calculated from facial tracking and eye tracking data for a given device with one another further refines the computed user engagement value for each given user equipment device in the network.

In some embodiments, control circuitry 304 may aggregate engagement level data received from multiple networked devices for a particular user with respect to each of the networked devices. For example, control circuitry 304 may receive user engagement level data for the parent from several devices that the user is currently engaged with. If the parent is using a smartphone, the smartphone may calculate an engagement level of the parent with the smartphone and transmit that engagement level information to user equipment 300 over the wireless network. If the parent is using a tablet computer, the tablet computer may compute the parent's engagement level with the tablet computer and transmit that information to user equipment 300. Control circuitry 304 may aggregate the parent's engagement level with respect to the various networked devices such as the smartphone and the tablet computer. Control circuitry 304 may factor these engagement vales with the engagement value calculated at the user equipment 300 for the parent with respect to display 312. In this manner, engagement tracking may be distributed across several networked devices and aggregated by control circuitry 304.

In another embodiment, engagement tracking circuitry 316 may detect that the user is engaged with another device using an optical device. For instance, engagement circuitry may detect that a user is talking on a telephone by processing a captured image of the user talking on the phone. Accordingly, control circuitry 304 adjusts the user's engagement level when it determines that user is engaged with another device from an image or a video capture. For example, control circuitry 304 may scan a captured image to detect a cellphone or another electronic device in the hands of a user. Control circuitry 304 may decrease the user's previously calculated engagement level proportionately based on the user's activity with the cellphone or any other secondary electronic device.

In some embodiments, engagement tracking circuitry 316 may monitor the applications and content running on user equipment device 300. For instance, if a user is using a social media application on his smartphone, the smartphone's engagement tracking circuitry 316 is able to monitor that the user is currently using a social media application and use that information to calculate a user engagement value for the user with respect to the smartphone. The calculated user engagement value on the networked smartphone may be transmitted to other user equipment devices to adjust the user's engagement value with those devices in light of his engagement with the social media application use on the smartphone. Control circuitry 304 may be configured to receive the engagement value of the user with respect to the smartphone and decrease the user engagement level with respect to user equipment device 300. Control circuitry 304 may decrease the engagement level value that may have been previously stored in storage 308 by an amount proportionate to the received user engagement level from the smartphone. In another implementation engagement tracking circuitry 316 may reduce the engagement level value calculated by the face tracking and eye scores before storing the computed engagement level value into storage 308. Although a smartphone has been used an example in this discussion, the method described may be used with any electronic device capable of transmitting data over a wireless network.

In yet another embodiment, engagement tracking circuitry 316 may determine a user's level of engagement by determining if the user is engaged in a conversation. Engagement tracking circuitry 316 may include audio detection circuitry such as a microphone and audio recognition software that is able to identify that the user associated with a user profile is engaged in a conversation. Accordingly, control circuitry 304 adjusts the user's engagement level when it determines that user is engaged in a conversation. For example, control circuitry 304 may receive audio data from a microphone and process a received sound file to detect whether a user is engaged in a conversation. Control circuitry 304 may detect the user's voice by comparing the audio profile from the sound file a database of user audio profiles. Control circuitry 304 may retrieve such a database of audio profiles from storage 308. Once control circuitry 304 determines that it is indeed the user who is engaged in a conversation, control circuitry 304 may decrease the engagement level of the user with respect to user equipment device 300.

In another embodiment, control circuitry 304 may determine whether a user is engaged in a conversation with other users about the media asset being displayed on user equipment 300. Control circuitry 304 may be configured to identify certain keywords associated with the media asset being displayed. For instance, control circuitry 304 may receive keywords associated with a media asset from a media content source. Control circuitry 304 may store the received keywords in storage 308. Control circuitry 304 may also receive audio data from one or more microphones located in the viewing region of user equipment 300. Control circuitry 304 may process the received audio data to detect whether a user is talking about the program. Control circuitry 304 may process the received audio using audio detection or speech recognition algorithms. Control circuitry 304 may further compare the processed audio against the keywords stored in storage 308 that are related to the currently displayed media asset.

Once control circuitry 304 detects that the user is talking about the media asset currently displayed on user equipment 300, control circuitry 304 may modify the user's engagement level. For example, control circuitry 304 may detect which user is talking about the currently displayed media asset by comparing the detected voice from the received audio against the database of user profiles stored in storage 308. Once control circuitry 304 identifies which user is speaking about the currently displayed media asset, control circuitry 304 may increase the detected user's engagement level with respect to user equipment 300. As an example, if control circuitry 304 detects that the parent spoke out loud the title of the media asset being currently displayed on user equipment 300, control circuitry 304 may increase the parent's engagement level with user equipment 300. In another embodiment, control circuitry 304 may increase the user engagement level by an amount proportionate to the frequency in which the user mentions keywords related to the currently displayed media asset on user equipment 300.

In another embodiment, control circuitry 304 may detect whether a user is engaged in conversation with another user present in the viewing region of the user equipment 300. For example, control circuitry 300 may detect whether multiple users present in the viewing region of user equipment 300 are conversing. Control circuitry 304 may be configured to detect that multiple users are speaking with one another using information acquired from engagement tracking circuitry 316. For example, control circuitry 304 may analyze audio and image data received from engagement tracking circuitry 316 to determine that multiple users are speaking with one another. If control circuitry 304 determines that the users are talking about the media asset currently displayed, control circuitry 304 may increase the users' engagement level with user equipment 300. Alternatively, if control circuitry 304 determines that the users are not talking about the media asset currently displayed on user equipment 300, control circuitry 304 may decrease the user engagement levels of the users that it detects are engaged in a topic not related to the currently displayed media asset.

In another embodiment, control circuitry 304 may determine a user's engagement level with user equipment device 300 by monitoring the user's interactions with the device from the amount of communications received from the user through user input interface 310. Such user interaction data is processed by control circuitry 304 and is passed to engagement tracking circuitry 316 to factor into a total calculation of the user's engagement level.

Storage 308 may include a stored database of user profiles associated with user equipment device 300. Each user profile may include at least one or more images of a user's face, parental control settings associated with the user, age, media viewing preferences of the user, and a threshold value for the user's engagement level. A user profile may include data describing the user's content authorization level. The content authorization level comprises a set of rules that governs what types of content the user associated with the user profile is permitted to access. For example, a user may be permitted to access media content associated with specific parental control ratings, genres, subjects, and broadcast times. A user profile may also include a default user engagement level threshold. An engagement level threshold is a numerical measure of a user's level of activity with user equipment device 300. Such a value may be calibrated in accordance with the techniques in which control circuitry 304 calculates a user engagement level using data from eye tracker 320, face tracker 318, and any other components of engagement tracking circuitry 316. Such a user engagement level threshold may be modified by a parent to change the level of engagement a parent needs to maintain with a user device in order for a child to view otherwise restricted content with parental supervision.

After control circuitry 304 calculates the engagement level for a user, control circuitry 304 may compare the calculated engagement level value against the user's a threshold engagement value to determine if the user is adequately engaged with user equipment device 300 for several features of the context aware media control system to be implemented. For example, control circuitry 304 may retrieve the threshold user engagement value from the user's profile stored in a memory of the first user equipment device, such as storage 308. Upon retrieving such a threshold value, control circuitry 304 may compare the previously calculated user engagement level, which may be stored in storage 308, against the threshold user engagement level threshold. Alternatively, control circuitry 304 may be configured to retrieve the user engagement level threshold from an alternative storage location. If control circuitry 304 determines that the calculated user engagement level value matches or exceeds the user engagement threshold, control circuitry 304 may store an indication that the user is sufficiently engaged with user equipment device 300 to meet the parental supervision requirements necessary to allow a child to watch otherwise restricted content. On the other hand, if control circuitry 304 determines that the calculated user engagement level value is less than the stored user engagement threshold, control circuitry 304 may determine that the user is not sufficiently engaged with user equipment device 300 to provide parental supervision to a child to access otherwise restricted content.

A user may be allowed to modify the user engagement threshold value for one or more user profiles. For instance, a parent can modify the engagement level threshold for one or more user profiles to a desired level through user input interface 310. Control circuitry 304 may receive the parent's changes inputted using user input interface 310 and accordingly modify the threshold engagement level value for a user profile stored in storage 308 with an updated value to be used in the future.

In some embodiments, control circuitry 304 may monitor a user's engagement level once it determines that the user is not paying sufficiently engaged with user equipment device 300. Control circuitry 304 may periodically check to determine whether a user is sufficiently engaged with user equipment device 300 before taking any action resulting from the user's level of engagement having changed to not sufficient engaged. For example, when control circuitry 304 first determines that a user's engagement level has fallen below the parent's engagement level threshold required to allow a child to watch content restricted without parental supervision, control circuitry 304 may begin running a countdown timer for a predetermined amount of elapsed time of acceptable minimal parental engagement. Control circuitry 304 may periodically measure the parent's engagement level value and check against the threshold engagement value to determine if the parent has increased his engagement level value to a value above the threshold throughout during this predetermined period of time. Alternatively, control circuitry 304 may continuously measure the parent's engagement level value and check against the threshold engagement value to determine if the parent has increased his engagement level value to a value above the threshold throughout during this predetermined period of time. If control circuitry 304 determines that the parent has not raised his engagement level above the threshold value required for parental supervision, control circuitry 304 may take the appropriate actions necessary to block a child from accessing media content at user equipment device 300 that the child is not allowed to access without adequate parental supervision.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, parental control settings, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5A shows an embodiment of eye tracker 500 for identifying the gaze point of a user 508 of user equipment 300. Eye tracker 500 includes processor 502, light source 504, and optical sensor 506. Light source 504 transmits light that reaches at least one eye of a user, and optical sensor 506 is directed at the user to sense reflected light. Optical sensor 506 transmits collected data to processor 502, and based on the data received from optical sensor 506, processor 502 determines a user's gaze point.

In some embodiments, eye tracker 500 is configured for determining a gaze point of a single user. In other embodiments, eye tracker 500 may determine gaze points for a plurality of users. Eye tracker 500 may identify multiple users of user equipment device 300, and a user of user equipment device 300 or eye tracker 500 may select one of the identified users whose eyes will be tracked.

Processor 502 may be integrated with one or more light source 504 and one or more optical sensor 506 in a single device. Alternatively, one or more light sources 504 and one or more optical sensors 506 may be housed separately from processor 502 and in wireless or wired communication with processor 502. One or more of processor 502, light source 504, and optical sensor 506 may be integrated into user equipment device 300.

Processor 502 may be similar to processing circuitry 306 described above. In some embodiments, processor 502 may be processing circuitry 306, with processing circuitry 306 in communication with light source 504 and optical sensor 506. In other embodiments, processor 502 may be separate from but optionally in communication with processing circuitry 306.

Light source 504 transmits light to one or both eyes of one or more users. Light source 504 may emit, for example, infrared (IR) light, near infrared light, or visible light. The light emitted by light source 504 may be collimated or non-collimated. The light is reflected in a user's eye, forming, for example, the reflection from the outer surface of the cornea (i.e., the first Purkinje image), the reflection from the inner surface of the cornea (i.e., the second Purkinje image), the reflection from the outer (anterior) surface of the lens (i.e., the third Purkinje image), and/or the reflection from the inner (posterior) surface of the lens (i.e., the fourth Purkinje image).

Optical sensor 506 collects visual information, such as an image or series of images, of one or both of one or more users' eyes. Optical sensor 506 transmits the collected image(s) to processor 502, which processes the received image(s) to identify a glint (i.e., corneal reflection) and/or other reflection in one or both eyes of one or more users. Processor 502 may also determine the location of the center of the pupil of one or both eyes of one or more users. For each eye, processor 502 may compare the location of the pupil to the location of the glint and/or other reflection to estimate the gaze point. Processor 502 may also store or obtain information describing the location of one or more light sources 504 and/or the location of one or more optical sensors 506 relative to display 312. Using this information, processor 502 may determine a user's gaze point on display 312, or processor 502 may determine whether or not a user's gaze point is on display 312.

In particular, processor 502 may identify locations on display 312 using a coordinate system, and processor 502 may identify an (x, y) coordinate representing the user's gaze point on display 312. For example, for a rectangular display, the lower left hand corner may be considered the origin and be assigned the coordinates (0, 0). Moving up display 312, the y-coordinate increases, and moving towards the right on the display, the x-coordinate increases. Any scale for the x and y axes may be used. Alternative coordinate system may be used; for example, the center point of display 312 may be the origin, or any other corner of display 312 may be the origin. The locations of light sources 504 and/or sensors 506 may be identified using this coordinate system. The coordinate system may include a third dimension.

In some embodiments, eye tracker 500 performs best if the position of the user's head is fixed or relatively stable. In other embodiments, eye tracker 500 is configured to account for a user's head movement, which allows the user a more natural viewing experience than if the user's head were fixed in a particular position.

In some embodiments accounting for a user's head movement, eye tracker 500 includes two or more optical sensors 506. For example, two cameras may be arranged to form a stereo vision system for obtaining a 3D position of the user's eye or eyes; this allows processor 502 to compensate for head movement when determining the user's gaze point. The two or more optical sensors 506 may be part of a single unit or may be separate units. For example, user equipment device 300 may include two cameras used as optical sensors 506, or eye tracker 500 in communication with user equipment device 300 may include two optical sensors 506. In other embodiments, each of user equipment device 300 and eye tracker 500 may include an optical sensor, and processor 502 receives image data from the optical sensor of user equipment device 300 and the optical sensor of eye tracker 500. Processor 502 may receive data identifying the location of optical sensors 506 relative to display 312 and/or relative to each other and use this information when determining the gaze point.

In other embodiments accounting for a user's head movement, eye tracker 500 includes two or more light sources for generating multiple glints. For example, two light sources 504 may create glints at different locations of an eye; having information on the two glints allows the processor to determine a 3D position of the user's eye or eyes, allowing processor 502 to compensate for head movement. Processor 502 may also receive data identifying the location of light sources 504 relative to display 312 and/or relative to each other and use this information when determining the gaze point.

In some embodiments, other types of eye trackers that do not utilize a light source may be used. For example, optical sensor 506 and processor 502 may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye tracker 500.

FIG. 5B shows an embodiment of face tracker 550 for identifying the facial position and tilt of a user 558 of user equipment 300 with respect to display 312. Face tracker 550 includes processor 552, light source 554, image sensor 506. Light source 554 transmits light that reaches the face of a user, and image sensor 556 and infrared sensor 560 are directed at the user's face to sense reflected light. Image sensor 556 transmits collected data to processor 552, and based on the data received from image sensor 556, processor 552 determines a user's facial position and tilt.

In some embodiments, face tracker 550 is configured for determining facial position and tilt of a single user. In other embodiments, face tracker 550 may determine facial position and tilt for a plurality of users. Face tracker 550 may identify multiple users of user equipment device 300, and a user of user equipment device 300 or face tracker 550 may select one of the identified users whose faces will be tracked.

Light source 554 transmits light to the face of one or more users. Light source 554 may emit, for example, infrared (IR) light, near infrared light, or visible light. The light emitted by light source 554 may be collimated or non-collimated. The light from light source 554 illuminates user's face 558 for image sensor 556 and infrared 556 to capture a clear image of the user's face.

Image sensor 556 and infrared sensor 560 collect visual information, such as an image or series of images, of one or more users' faces. Image sensor 556 and infrared sensor 560 transmit the collected image(s) to processor 552, which processes the received image(s) and implements a facial detection algorithm on the collected image(s). The facial detection algorithm may process the captured image(s) and compare the processed images against a database of previously stored users' faces in storage 308. A database of user profiles associated with the user equipment device 300 may be stored in storage 308. Each user profile in such a database may contain one or more images of the user associated with the user profile. Processor 552 may compare the processed image(s) received from image sensor 556 and infrared sensor 560 against the stored image(s) in the user profile database to identify which user profile corresponds to the detected user. Once the user is identified, control circuitry 304 adds the detected user profile to a list of active user profiles near the user equipment device 300.

Face tracker 550 may use image sensor 556 and infrared sensor 560 in tandem or may use only image sensor 556 or infrared sensor 560.

Processor 502 may also determine the location of a user's face with relation to display 312. Processor 502 may measure the size of the face in the image(s) captured by optical sensor 506 to determine the distance of the user from display 312.

Processor 502 may also determine the tilt and orientation of a user's face with relation to display 312. Processor 502 may process the captured image(s) of a user's face and may execute a facial feature detection algorithm to determine the degree of tilt of a user's face with respect to the optical sensor. Since the optical sensor may be placed near or attached to display 312, the degree of tilt of a user's face from the optical sensor will be the same degree of tilt from display 312. Such an algorithm will detect whether the user is looking straight at display 312 or is looking away from display 312.

Image sensor 556 and infrared sensor 560 may collect a series of images or a video of the user's face. By analyzing the series of images or different video frames captured over a span of time, processor 552 may execute a facial tracking algorithm to determine changes in the position and orientation of face 558 with respect to a display device such as display 312.

In some embodiments accounting for a user's head movement, face tracker 318 includes two or more optical sensors 506. For example, two cameras may be arranged to form a stereo vision system for obtaining a 3D position of the user's face; this allows processor 502 to compensate for head movement when determining the facial position. The two or more optical sensors 506 may be part of a single unit or may be separate units. For example, user equipment device 300 may include two cameras used as optical sensors 506, or face tracker 318 in communication with user equipment device 300 may include two optical sensors 506. In other embodiments, each of user equipment device 300 and face tracker 550 may include an optical sensor, and processor 502 receives image data from the optical sensor of user equipment device 300 and the optical sensor of face tracker 550. Processor 502 may receive data identifying the location of optical sensors 506 relative to display 312 and/or relative to each other and use this information when determining the user's facial position and tilt.

In some embodiments, other types of face trackers that do not utilize a light source may be used. Any other equipment or method for determining one or more users' facial position and tilt not discussed above may be used in addition to or instead of the above-described embodiments of face tracker 550.

FIG. 6 depicts an environment in which the context aware media control system of user equipment device 300 is implemented. In some embodiments of viewing region 600 of user equipment device 300, a parent 610 views a media asset displayed on display screen 630 along with a child 620. Display screen 630 corresponds to display 312 of user equipment device 300. User equipment device 650 outputs media assets and other suitable audiovisual content to display screen 630. User equipment device 650 includes control circuitry 304 of user equipment device 300 and may also include a portion or all of engagement tracking circuitry 316. Image sensor 640 may also include a portion or all of engagement tracking circuitry 316. In other embodiments, control circuitry 304 may be included in display screen 630.

In some embodiments, a child 620 is initially the only user present in viewing region 600. Control circuitry 304 detects that a user is present. The child may power on display screen 630 and user equipment device 650. In an alternative implementation, display screen 630 and user equipment device 650 may automatically power on upon detecting user presence in viewing region 600. Upon detecting a user, control circuitry 304 may display a prompt on display screen 630 for the child 620 to log in with user equipment device 300. Alternatively, control circuitry 304 may automatically log in the child by facial detection. For example, once control circuitry 304 detects movement in viewing region 600, control circuitry 304 may instruct image sensor 640 to capture images of viewing region 600. Control circuitry 304 may perform facial detection to detect which user is present in viewing region 600. For example, control circuitry 304 may process the captured images from image sensor 640 and compare the detected faces against a database of user profiles stored in storage 308. Once a facial match is detected with a registered user profile, control circuitry 304 identifies child 620's user profile from the user profile database stored in storage 308. Control circuitry 304 may prompt a user to log in manually if it cannot successfully identify the user using facial detection. Additionally, control circuitry 304 may prompt a user to create a profile if the user is not registered with user equipment device 650.

In some embodiments, if control circuitry 304 determines that child 620 is the only user present in viewing region 600, then control circuitry 304 applies the parent control settings associated with child 620 from child 620's user profile upon logging in child 620 at user equipment device 650. As an illustrative example, child 620's user profile settings may allow access to media assets with a parental guidance rating of “G” or lower without any parental supervision. Accordingly, in the scenario when no other user is detected, control circuitry 304 may only allow child 620 to access media assets with a content rating of “G” or lower. When child 620 requests access to media content with a content rating above “G” that is inaccessible without parental supervision, control circuitry 304 may generate a notification message on display screen 630 that the child is not allowed to access the requested content without parental supervision.

Image sensor 640 may continuously or periodically check for the presence of additional users in viewing region 600. If another user 610 is detected and logged in, control circuitry 304 accesses user 610's user profile from the user profile database in storage 308.

In some embodiments, control circuitry 304 may receive a request to access a media asset when both a parent 610 and child 620 are present in viewing region 600. Control circuitry 304 may detect which users are logged on user equipment device 650. Control circuitry 304 may check the user profiles of all active users in viewing region 600 to determine if parental control settings in the active users' profiles prevents them from accessing the requested media content. As an example, if control circuitry 304 determines that the requested media asset has a parental content rating of “PG” and that child 620 is only allowed to access content with a parental content rating of “G” or below without parental supervision. Control circuitry 304 may further determine from the user profile of child 620 that child 620 is allowed to access media content with a content rating of “PG” with parental supervision. In such a scenario, control circuitry 304 further determines whether a parent is present. Upon detecting parent 610, control circuitry 304 determines whether a parent 610 is allowed to access the requested media content. Control circuitry 304 may determine whether the user is a parent or has the parental control setting to a less restrictive set of media content than those allowed for child 620. For example, control circuitry 304 may check the user's profile stored in storage 308 to determine whether the user has a higher content authorization level than child 620. Control circuitry 304 may allow user equipment device 650 to access a media asset that user 610 has access to but is otherwise inaccessible to child 620 without active parental supervision upon determining that user 610 is sufficiently engaged with display screen 630.

Once a user is detected in viewing region 600, engagement tracking circuitry 316 begins eye tracking and face tracking as described in connection with FIG. 5 to determine the user's level of engagement. As described above in connection with FIG. 3, engagement tracking circuitry 316 calculates a value for the user's level of engagement with display screen 630 based on the eye tracking and face tracking data. In addition, engagement tracking circuitry 316 further adjusts the user's engagement level value by detecting what other devices the user is currently engaged with. In addition, engagement tracking circuitry 316 further adjusts the user's engagement level value by detecting whether the user is engaged in a conversation. The level of engagement value for any user may be continuously or periodically updated to accurately gauge the current level of user engagement with display screen 630.

When access to a media content is requested at user equipment device 650, control circuitry 304 may determine whether a child 620 is present in viewing region 600. If a child 620 is detected, control circuitry 304 may determine whether child 620 has access to the requested content. Control circuitry 304 checks child 620's user profile for parental control rules and applies the parental control rules to the media attributes associated with the media content listing of the requested media content. If control circuitry 304 determines that child 620 has access to the requested content, then control circuitry 304 may direct user equipment device 650 to access the requested content. However, if control circuitry 304 determines that child 620 does not have access to the requested content, control circuitry 304 may detect whether there is a user in viewing region 600 that has access to the requested media content. Upon detecting that parent 610 is logged into user equipment device 650, control circuitry 304 may check parent 610's user profile for parent control rules and applies the parental control rules to the media attributes associated with the media content listing of the requested media content. If control circuitry 304 determines that parent 610 does not have access to the requested media content, control circuitry 304 may check for any additional users in viewing region 600 that may have access to the requested media content. If control circuitry 304 determines that no user in viewing region 600 has access to the requested media content, control circuitry 304 may not allow user equipment device 650 to access the requested media content and instead may display a notification message on display screen 630 stating that the requested content is above the access settings associated with the detected users. However, if control circuitry 304 determines that parent 610 has access to the requested media content, then control circuitry 304 compares the parent 610's most recent user engagement level against a predetermined parental engagement value stored in a database in storage 308. If control circuitry 304 determines that parent 610's calculated user engagement level matches or exceeds the parental control threshold value, control circuitry 304 allows the requested media content to be accessed on user equipment device 650. However, if control circuitry 304 determines that parent 610's most recently calculated user engagement level is less than the parental control threshold value, control circuitry 304 prevents the requested media content from being accessed on user equipment device 650.

In another embodiment, control circuitry 304 may begin a countdown timer once it determines that parent 610's most recently calculated user engagement level is less than the parental control threshold value. Throughout the course of this countdown period, control circuitry 304 may check to see whether the parent 610 has increases his engagement level by monitoring parent 610's activity. If control circuitry 304 determines that the parent has indeed increased his engagement level before the countdown clock reaches a predetermined timeout period, control circuitry 304 may reset the countdown clock and continue accessing the requested media content. However, if control circuitry 304 determines that parent 610 has not increased his engagement level above the parental control engagement threshold, control circuitry 304 may prevent the requested media content from being accessed on user equipment device 650. A default predetermined timeout period may be set on user equipment device 300. In an implementation, a parent may be allowed to change this default timeout period during which the parent's engagement level is monitored until the system determines that access to content not available to a child without active parental supervision should be blocked. For instance, a parent may change this default timeout period using control circuitry 310. Control circuitry 304 may modify the predetermined timeout period stored in storage 304 upon receiving input from a user to change this value.

In an embodiment, control circuitry 304 may display a notification message on display screen 630 or may output an audio alert through speaker 314 alerting parent 630 to pay more attention to display screen 630 in addition to preventing the requested media content from being accessed on user equipment 650.

In another embodiment, once control circuitry 304 determines that child 620 is present in viewing region 600 and a media asset has been requested, control circuitry 304 may check whether the parental control settings of child 620's profile states that the requested media content belongs to a class of media content that the user is not allowed to access even with a parent present. If control circuitry 304 determines that the requested media asset belongs to such an “always restricted” class, control circuitry 304 prevents the requested media content to be accessed on user equipment device 650. Control circuitry 304 may instead display notification message on display screen 630 indicating that the requested media content is not allowed to be displayed since a child is present in the viewing area. Once control circuitry 304 detects that viewing region 600 does not have any children present, control circuitry 304 may access such a requested content.

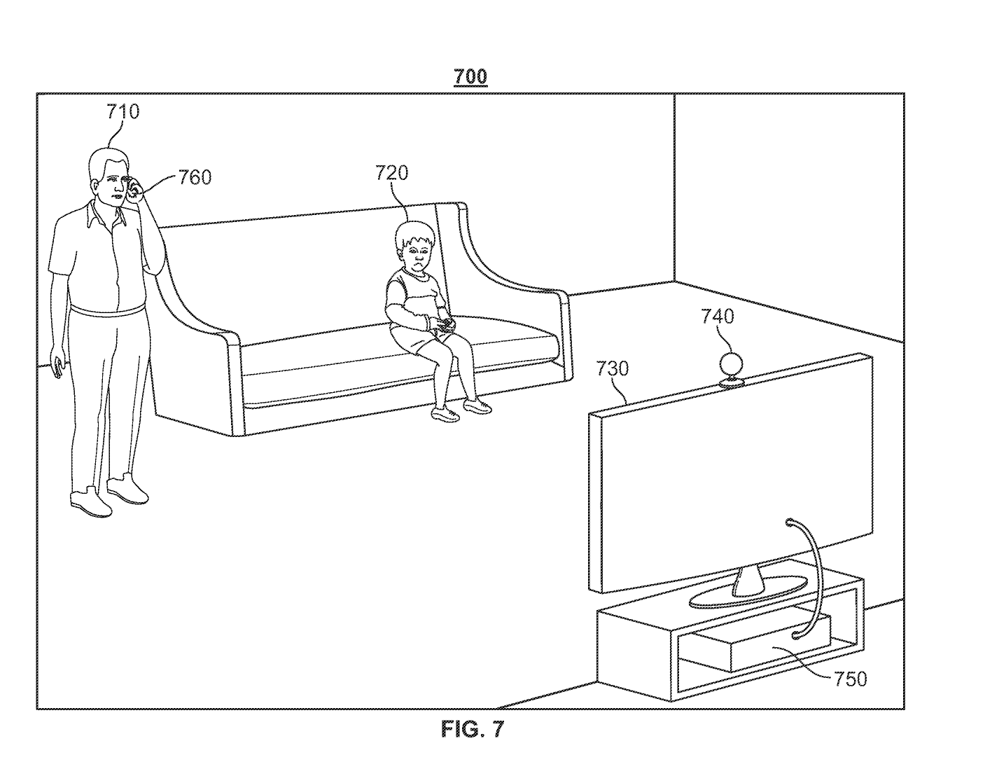

FIG. 7 shows another embodiment when the parent is engaged with a secondary device and may not be directing his undivided attention to the context aware media control system's display screen. Parent 710 and child 720 correspond to parent 610 and child 620 of FIG. 6. Display screen 730, image sensor 740, and user equipment device 750 correspond to display screen 630, image sensor 640, and user equipment device 650 of FIG. 6. In the embodiment shown in FIG. 7, parent 710 may be engaged with a secondary device, smartphone 760.

Engagement tracking circuitry 316, using image sensor 740, may determine that parent 710 is engaged with smartphone 760. Face tracker 318 and eye tracker 320 perform their respective face detection and eye tracking algorithms to measure the parent's level of attentiveness to display screen 730. In addition, engagement tracking circuitry 316 detects whether the user is merely using his smartphone or is actively engaged in a conversation as well. Smartphone 760 may also be a networked device that contains its own engagement tracking circuitry. The engagement tracking circuitry on smartphone 760 may run facial and eye tracking algorithms to measure parent 710's level of engagement with smartphone 760. In addition, the engagement tracking circuitry on smartphone 760 may monitor which applications parent 710 is using on the smartphone. Based on the user's measured interaction with smartphone 760, the engagement tracking circuitry of smartphone 760 may also communicate the level of engagement of parent 710 with smartphone 760. Control circuitry 304 may receive this level of engagement value of parent 710 with smartphone 760 and accordingly adjust the level of engagement value of parent 710 with display screen 730.

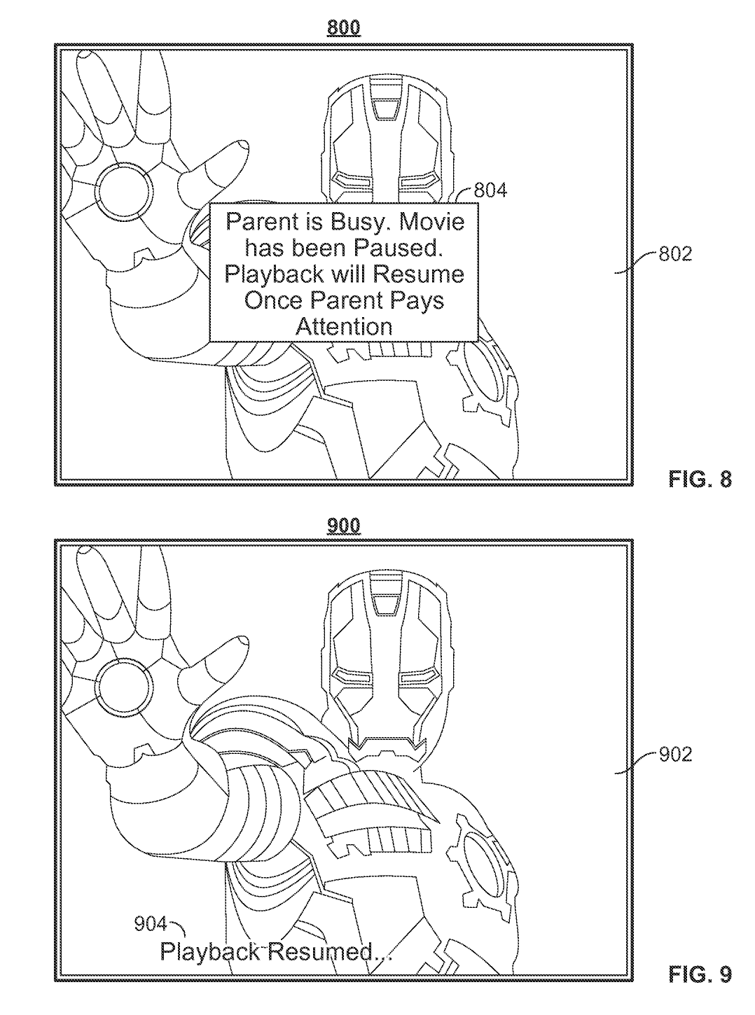

In an embodiment, parent 710 and child 720 may be viewing a media content displayed on display screen 730 that child 720 may not be allowed to view without active parental supervision when parent 710 starts using smartphone 760. Once control circuitry 304 calculates parent 710's level of engagement with display screen 730, control circuitry 304 compares the parent engagement value with a predetermined parental control engagement value stored in storage 308. If parent 710's engagement level value with display screen 730 matches or exceeds the predetermined parent control engagement level threshold, control circuitry 304 continues the uninterrupted access of the media content displayed on display screen 730. However, once control circuitry 304 determines that parent 710's engagement level value with display screen 730 is less than the predetermined parent control engagement level threshold, control circuitry 304 prevents the uninterrupted access of the media content displayed on display screen 730, as described below in connection with FIG. 8.

In another embodiment, not shown in FIG. 7, parent 710 may have fallen asleep in front of display screen 730. Since engagement tracking circuitry 316 can use both a face tracker and an eye tracker, eye tracking data from eye tracker 320 will indicate that parent 710 has fallen asleep. In addition, face tracker 318 may also indicate whether the user's facial position and orientation with relation to display screen 730 has changed as is often characteristic of a viewer who has fallen asleep. Parent 710's engagement level with display screen 730 may be updated in response to this new engagement data received by engagement tracking circuitry 316. Once control circuitry 304 updates parent 710's level of engagement with display screen 730, control circuitry 304 compares the parent engagement value with a predetermined parental control engagement value stored in storage 308. If parent 710's engagement level value with display screen 730 matches or exceeds the predetermined parent control engagement level threshold, control circuitry 304 continues the uninterrupted access of the media content displayed on display screen 730. However, once control circuitry 304 determines that parent 710's engagement level value with display screen 730 is less than the predetermined parent control engagement level threshold, control circuitry 304 prevents the uninterrupted access of the media content displayed on display screen 730, as described below in connection with FIG. 8.

Since engagement tracking circuitry 316 monitors user engagement continuously or periodically, engagement circuitry 316 can update parent 710's engagement level value with display screen 730 when parent 710 stops using smartphone 760 or wakes up. As parent 710 resumes directing his undivided attention to display screen 730, engagement tracking circuitry 316 updates the user engagement value of parent 710 with display screen 730. Control circuitry 304 resumes the uninterrupted access of media content whose access may have previously been disrupted when parent 710 was distracted or asleep.

FIG. 8 shows an illustrative display screen displayed on display screen 730 of FIG. 7 when control circuitry 304 prevents the uninterrupted access of the media content as a parent's level of engagement falls below a predetermined threshold required to access the media asset. Before control circuitry 304 had prevented accessing the requested media asset, user equipment device 750 was playing back the movie “Iron Man” on display screen 730.

In the embodiment depicted in FIG. 8, once control circuitry 304 detects that parent 710's engagement level value has fallen below the necessary predetermined threshold value required to continue accessing the “Iron Man” movie, control circuitry 304 pauses playback of the “Iron Man” movie. Control circuitry 304 may further instruct the media guidance application running on user equipment device 750 to display message 804 on screen 730. Message 804 is a message that indicates that that parent is busy and that playback of the “Iron Man” movie has been paused. Message 804 may further indicate that in order to resume playback, the parent needs to pay attention to display 730. Message 804 may be overlaid on top of the displayed media asset 802 as show in FIG. 8. Alternatively, message 804 may be shown in a non-overlapping region of screen 800 along with the display of the paused media asset 802 on a different region of screen 800.

In another embodiment, control circuitry 304 may also play an audio alert to alert the parent that media asset 802 has been paused because the parent is busy. The audio alert may also indicate that playback of paused media asset 802 will resume once the parent pays attention to display screen 730.

Once the parent resumes paying attention to display screen 730 and control circuitry 304 determines that the updated user engagement value matches or exceeds the predetermined threshold value required to view the “Iron Man” movie, control circuitry 304 may resume playback of the media asset. Control circuitry 304 may further instruct the media application guide to display a screen such as screen 900 displayed in FIG. 9.

Control circuitry 304 may instruct the media application guide to remove the display of message 804 and resume playback of the paused “Iron Man” movie once the parent's engagement level value satisfies the required predetermined threshold value. Control circuitry 304 may resume playback of the “Iron Man” movie from the point where the movie was paused. In addition, control circuitry 304 may further instruct media application guide to display an indicator 904. Indicator 904 may be any combination of graphics and text. Indicator 904 may indicate the playback of the previously paused media asset has resumed. In FIG. 9, indicator 904 includes a playback icon and text to indicate that playback of the previously paused “Iron Man” movie has resumed. Indicator 904 may be overlaid on top of the display of the media asset 902.

In another embodiment, once control circuitry 304 detects that the parent's level of engagement has fallen below a predetermined threshold required to access the “Iron Man” media asset, control circuitry 304 may display an alternative media asset on display screen 730. The alternative media asset may be a media asset that child 720 is allowed to access without any parental supervision or with minimal parental supervision. Once control circuitry 304 determines that parent 710 has resumed paying attention to display screen 730, control circuitry 304 may resume playback of the previously paused “Iron Man” movie from a playback location where the media asset was previously paused. Alternatively, control circuitry 304 may display a prompt on display screen 700 to ask permission to switch back to the previously paused “Iron Man” movie or continue playing the alternative media asset.

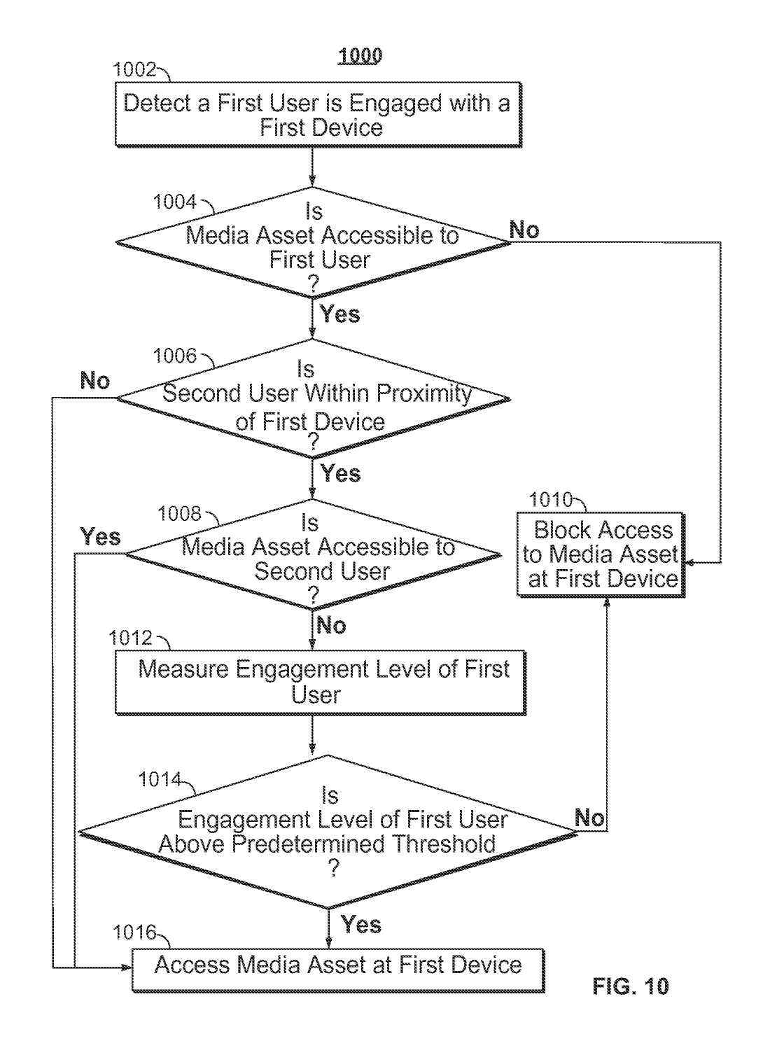

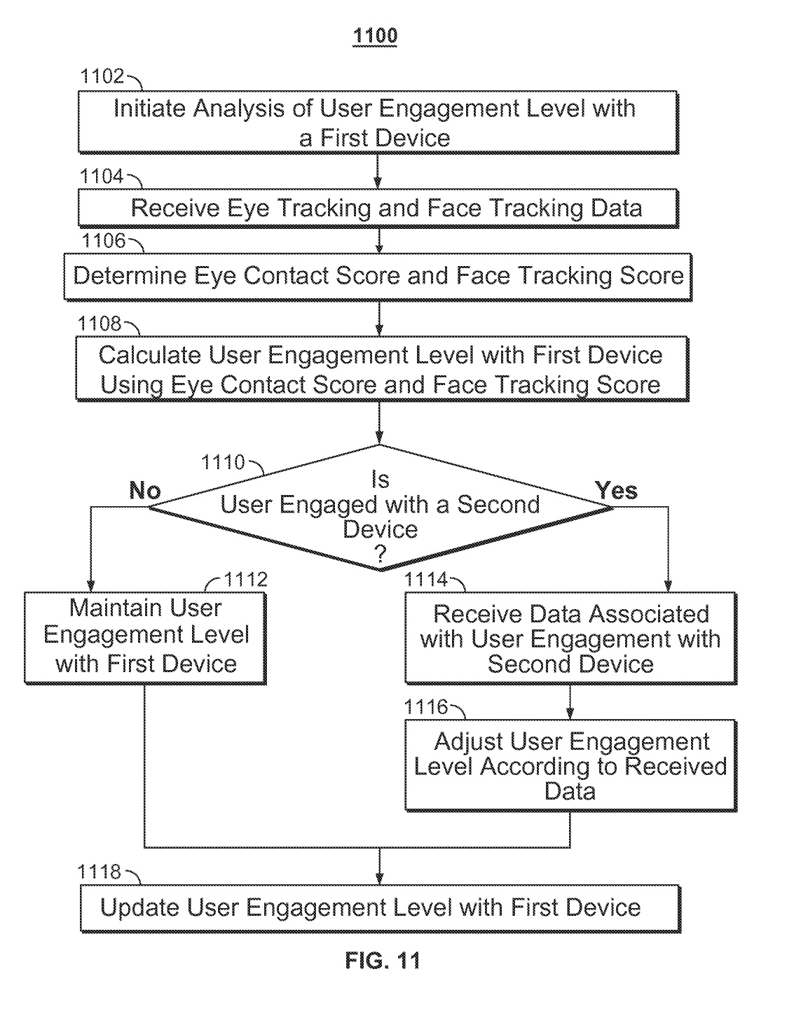

The flow diagrams of FIGS. 10-11 serve to illustrate processes involved in the embodiments described above. Where appropriate, these processes may, for example, be implemented completely in the processing circuitry of a user equipment device (e.g., control circuitry 304 of FIG. 3) or may be implemented at least partially in a remote server. It should be understood that the steps of the flow charts are merely illustrative and any of the depicted steps may be modified, omitted, or rearranged, two or more of the steps may be combined, or any additional steps may be added, without departing from the scope of the disclosure. Also, some of the steps may be executed or performed substantially simultaneously where appropriate or in parallel to reduce latency and processing times.

At step 1002, control circuitry 304 determines whether a first user is engaged with a first device. For example, control circuitry 304 may receive face detection information from face tracker 318. Control circuitry 304 can process this face detection information and determine which user profile registered with the user equipment device 300 corresponds to the detected first user. In the embodiment shown in FIG. 6, control circuitry 304 detects parent 610 is within viewing region 600. Control circuitry 304 logs in parent 610 and accesses his user profile from storage 308.

At step 1004, control circuitry 304 determines whether the requested media asset is accessible to the first detected user without another user's presence. Control circuitry 304 may check the user profile of the first detected user for parental control access settings in making this determination. If control circuitry 304 determines that the first user is not allowed to access the requested media asset, control circuitry 304 blocks access to the media asset at the first user equipment device at step 1010. In the embodiment shown in FIG. 6, control circuitry 304 checks the user profile of parent 610 to determine whether parent 610 is allowed to view the requested media content without any additional supervision.

At step 1006, in response to determining that the first user is allowed to access the requested media content without another user's presence, control circuitry 304 determines whether a second user is present within proximity of the first user equipment device. Such a determination may also be made by the face detection mechanisms described above. In the embodiment shown in FIG. 6, control circuitry 304 may detect that a child 620 is present in viewing region 600. Accordingly, child 620 is logged onto user equipment device 650 and control circuitry 304 may retrieve the user profile of child 620.

If control circuitry 304 determines that a second user is not within proximity of the first media equipment device, control circuitry 304 accesses the requested media asset at step 1016. In the embodiment shown in FIG. 6, control circuitry 304 accesses the requested media asset if it determines that no children are within in viewing region 600.

At step 1008, in response to determining that a second user is within proximity of the first user equipment device at step 1006, control circuitry 304 further determines whether the requested media asset is accessible to the second user. For example, control circuitry 304 identifies the user profile associated with the detected second user using face detection mechanisms described above. Control circuitry 304 may check the parental control settings associated with the second user's user profile to determine whether the requested media content is accessible to the second user. In the embodiment shown in FIG. 6, control circuitry 304 determines whether child 620 is allowed to access the requested media asset by checking the user profile of child 620 for any parental control settings that may apply to the requested media asset.

If control circuitry 304 determines that the media asset is accessible to the second user, then control circuitry 304 accesses the media asset at the first device or continues accessing the media asset at the first device as shown at step 1016. In the embodiment shown in FIG. 6, if control circuitry 304 determines that child 620 is allowed to access the requested program by checking child 620's user profile, then the requested media program is accessed at user equipment device 650 and displayed on display screen 630.

At step 1012, upon determining that the requested media asset is not accessible to the second user, control circuitry 304 instructs engagement circuitry 316 to collect user engagement data by eye tracking and face tracking mechanisms. Control circuitry 304 processes the eye tracking and face tracking data along with engagement level values from other networked devices that the user may be operating to calculate a total engagement level value for the user with respect to the user equipment device. In the embodiment shown in FIG. 6, when control circuitry 304 determines that child 620 is not allowed to access the requested media asset without active parental supervision, control circuitry 304 instructs engagement tracking circuitry 318 to calculate the engagement level of parent 610.

At step 1014, control circuitry 304 compares whether the calculated engagement level value for the first user with respect to the user equipment device matches or exceeds a predetermined user engagement threshold required to access the requested media content. In the embodiment shown in FIG. 6, control circuitry 304 determines whether parent 610's calculated engagement level with display 630 matches or exceeds a predetermined engagement level threshold.

If control circuitry 304 determines that the engagement level of the second user with the first user equipment device is below the predetermined threshold, control circuitry 304 blocks access to the requested media asset at the first user equipment device at step 1010. In the embodiment shown in FIG. 6, if control circuitry 304 determines that the parent is not sufficiently engaged with display screen 630, access to the requested media asset is blocked at user equipment device 650. Control circuitry 304 may display the display screen of FIG. 8 in such a scenario where a prompt 804 informs the users that the parent is busy and that playback of the “Iron Man” movie will resume once parent 610 pays enough attention to display screen 630.

At step 1016, in response to determining that the engagement level of the second user with the first user equipment device matches or is above the predetermined threshold, control circuitry 304 accesses the requested media asset at the first user equipment device. In the embodiment shown in FIG. 6, when control circuitry 304 determines that parent 610 is paying sufficient attention to the requested asset, the requested media asset is accessed at user equipment device 650 and may be displayed at display screen 630.

FIG. 11 illustrates a flow diagram containing processes in accordance with an embodiment that describes the process in which a user's engagement level with a user equipment is determined in step 1012 of FIG. 10.

At step 1102, control circuitry 304 initiates analysis of the user's engagement level with a first user equipment device. In the embodiment shown in FIG. 6, control circuitry 304 determines that parent 610 is allowed to access the requested media asset and that child 620 is only permitted to view the requested media asset with active parental supervision. Control circuitry 304 may instruct engagement tracking circuitry 318 to collect engagement level data for parent 610 with respect to display screen 630.

At step 1104, control circuitry 304 receives eye tracking and face tracking data from engagement tracking circuitry 316, in particular from face tracker 318 and eye tracker 320. Control circuitry 304 may instruct face tracker 550 and eye tracker 500 to begin collecting face tracking and eye tracking information for parent 610 with respect to display screen 630.

At step 1106, control circuitry 304 processes the eye tracking data and face tracking data received from engagement tracking circuitry 316 and calculates an eye tracking score and a face tracking score. For example, processor 502 of eye tracker 500 analyzes eye tracking information received from optical sensor and calculates a numerical score based on the received eye tracking information. Similarly, processor 552 of face tracker 550 analyzes face tracking information received from image sensor 556 and infrared sensor 560 and calculates a face tracking score by processing the received face tracking using a face tracking algorithm. Processor 552 may calculate the face tracking score by analyzing a set of images or a video received from image sensor 556 and infrared sensor 556 to determine the level of engagement that parent 610 has with respect to display screen 630.

At step 1108, control circuitry 304 calculates the user engagement level with the first user equipment device using an eye contact score and a face tracking score. Control circuitry 304 may perform a weighted average of the face tracking score and eye tracking to calculate the user engagement level with user equipment device.

At step 1110, control circuitry 304 determines whether the user is engaged with a second device. Such a determination may be made by processing data received from engagement tracking circuitry 316. In the embodiment shown in FIG. 7, control circuitry 304 determines whether parent 710 is engaged a secondary device such as smartphone 760. Such a determination may be made using image sensor 740 or may be made upon receipt of engagement level information from smartphone 760 of parent 710 with smartphone 760.

At step 1112, in response to determining that the user is not engaged with a second device, control circuitry 304 maintains the user engagement level. In the embodiment shown in FIG. 6 and FIG. 7, if control circuitry 304 determines that the parent is not engaged with a second device, then the engagement level score calculated for the parent at step 1108 is maintained.

At step 1114, in response to determining that the user is engaged with a second device, control circuitry 304 receives data associated with user engagement level with the second device from engagement tracking circuitry 316. In the embodiment shown in FIG. 7, once control circuitry 304 determines that parent 710 is engaged with smartphone 760, control circuitry 304 instructs engagement tracking circuitry 316 to receive engagement level data for parent 710 with smartphone 760. In some instance, engagement tracking circuitry 316 receives parent 710's engagement level with smartphone 760 from smartphone 760 over a wireless network. Alternatively, image sensor 740 may collect images or video of user 710's use with smartphone 760. Control circuitry 304 may process such an image to calculate the user engagement level of parent 710 with smartphone 760.

At step 1116, upon processing the data associated with user engagement with second device, control circuitry 304 adjusts the user engagement level with the first user equipment device according to the received data. In the embodiment shown in FIG. 7, control circuitry 304 may decrease the user engagement level score calculated at step 1108 by subtracting the user engagement level value of parent 710 with smartphone 760 from the user engagement level score calculated at step 1108.

At step 1118, control circuitry 304 updates the user engagement level with the first user equipment device in accordance with all the received data. For example, control circuitry 304 may update the user engagement level value score stored in storage 308 with a the updated user engagement calculated in step 1116 if the user was engaged with a second user device. If the user was not engaged with a second user device, control circuitry 304 may use the user engagement level calculated at step 1108. Control circuitry 304 may compare the updated user engagement level value calculated at step 1118 with a predetermined user engagement level threshold stored in storage 308 to determine whether the user is sufficiently engaged.

It will be appreciated that while the discussion of media assets has focused on user engagement with videos displayed on a display screen, the principles described above can be applied to other types of media assets, such as audio and other types of media devices which may not use a display screen.

The foregoing is merely illustrative of the principles of the systems and methods described herein, and various modifications can be made by those skilled in the art without departing from the scope and spirit of the systems and methods described herein. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. The above described embodiments are presented for purposes of illustration and not of limitation, and the systems and methods described herein are limited only by the claims which follow.

1. A method for controlling playback of media assets, the method comprising:
detecting a second user within proximity of a first user equipment device, wherein the second user is restricted from accessing a media asset on the first user equipment device without a first user within proximity of the first user equipment device who has a content authorization level higher than the second user;
detecting the first user within proximity of the first user equipment device;
measuring an engagement level of the first user with the first user equipment device;
retrieving a first threshold value stored in a memory of the first user equipment device;
determining whether the measured engagement level of the first user with the first user equipment device is above the first threshold value; and
enabling access to the media asset at the first user equipment device upon determining that the measured engagement level of the first user with the first user equipment device is above the first threshold value.

2. The method of claim 1, further comprising determining whether the first user is allowed to access the media asset by accessing a first user profile.

3. The method of claim 2, wherein the media asset is accessed upon determining that the first user is allowed to access the media asset.

4. The method of claim 1, further comprising tracking the facial position of the first user with respect to the first user equipment device to measure the engagement level of the first user with the first user equipment device.

5. The method of claim 1, wherein measuring the engagement level of the first user with the first user equipment device further comprises:
tracking a gaze point of the first user with respect to the first user equipment device; and
setting a value to the engagement level of the first user with the first user equipment device based on the gaze-tracking.

6. The method of claim 1, further comprising:
accessing a second user profile for the second user upon detecting that the second user is within proximity of the first user equipment device;
determining whether the second user profile prevents access to the media content; and
preventing the second user from accessing the media content upon determining that the measured engagement level of the first user with the first user equipment device is below the first threshold value.

7. The method of claim 1, further comprising:
determining whether the first user is engaged with a second user equipment device;
measuring the engagement level of the first user with the second user equipment device; and
preventing access to the media asset at the first user equipment device upon determining that the measured engagement level of the first user with the second user equipment device is above a second threshold value.

8. The method of claim 7, wherein measuring the engagement level of the first user with the second user equipment device further comprises:
monitoring which application the first user is using on the second user equipment device; and
assigning a value to the engagement level of the first user with the second user equipment device based on the application that the first user is using on the second user equipment device.

9. The method of claim 7, wherein measuring the engagement level of the second user equipment device further comprises:
tracking a gaze point of the first user with respect to the second user equipment device; and
setting a value to the engagement level of the first user with the second user equipment device based on the gaze-tracking.

10. The method of claim 1, wherein determining whether the measured engagement level of the first user with the first user equipment device is above a first threshold value further comprises:
assigning a value to the engagement level of the first user with the first user device; and
comparing the engagement level value with the first threshold value stored in a database.

11. A system for controlling playback of media assets, the system comprising processing circuitry configured to:
detect a second user within proximity of a first user equipment device, wherein the second user is restricted from accessing a media asset on the first user equipment device without a first user within proximity of the first user equipment device who has a content authorization level higher than the second user;
detect a first user within proximity of the first user equipment device;
measure an engagement level of the first user with the first user equipment device;
retrieve a first threshold value stored in a memory of the first user equipment device;
determine whether the measured engagement level of the first user with the first user equipment device is above the first threshold value; and
enable access to the media asset at the first user equipment device upon determining that the measured engagement level of the first user with the first user equipment device is above the first threshold value.

12. The system of claim 11, wherein the processing circuitry is further configured to determine whether the first user is allowed to access the media asset by accessing a first user profile.

13. The system of claim 12, wherein the media asset is accessed upon determining that the first user is allowed to access the media asset.

14. The system of claim 11, wherein the processing circuitry is further configured to track the facial position of the first user with respect to the first user equipment device to measure the engagement level of the first user with the first user equipment device.

15. The system of claim 11, wherein the processing circuitry is further configured to:
track a gaze point of the first user with respect to the first user equipment device; and
set a value to the engagement level of the first user with the first user equipment device based on the gaze-tracking.

16. The system of claim 11, wherein the processing circuitry is further configured to:
access a second user profile for the second user upon detecting that the second user is within proximity of the first user equipment device;
determine whether the second user profile prevents access to the media content; and
prevent the second user from accessing the media content upon determining that the measured engagement level of the first user with the first user equipment device is below the first threshold value.

17. The system of claim 11, wherein the processing circuitry is further configured to:
determine whether the first user is engaged with a second user equipment device;
measure the engagement level of the first user with the second user equipment device; and
prevent access to the media asset at the first user equipment device upon determining that the measured engagement level of the first user with the second user equipment device is above a second threshold value.

18. The system of claim 11, wherein the processing circuitry is further configured to:
monitor which application the first user is using on the second user equipment device; and
assign a value to the engagement level of the first user with the second user equipment device based on the application that the first user is using on the second user equipment device.

19. The system of claim 11, wherein the processing circuitry is further configured to:
track a gaze point of the first user with respect to the second user equipment device; and
set a value to the engagement level of the first user with the second user equipment device based on the gaze-tracking.

20. The system of claim 11, wherein the processing circuitry is further configured to:
assign a value to the engagement level of the first user with the first user device; and
compare the engagement level value with the first threshold value stored in a database.

21-30. (canceled)
